(19) United States
(12) Patent Application Publication
(10) Pub. No.: US 2024/0323798 A1
(43) Pub. Date: Sep. 26, 2024

(54) CONFIGURING A WIRELESS COMMUNICATION TOPOLOGY

(71) Applicant: Lenovo (Singapore) Pte. Ltd., New Tech Park (SG)

(72) Inventors: Emmanouil Pateromichelakis, Viersen (DE); Dimitrios Karampatsis, Ruislip (GB)

(21) Appl. No.: 18/573,269

(22) PCT Filed: Aug. 20, 2021
(86) PCT No.: PCT/EP2021/073210

§ 371 Date: Dec. 21, 2023

(30) Foreign Application Priority Data
Jun. 22, 2021 (GR) 20210100412

(51) Int. Cl. H04W 40/12; H04W 24/10; H04W 84/20

(52) U.S. Cl. CPC H04W 40/12; H04W 24/10; H04W 84/20

(57) ABSTRACT

Apparatuses, methods, and systems are disclosed for configuring a wireless communication topology. One method includes obtaining an industrial field level communication requirement for configuring a wireless communication topology. The method includes determining the wireless communication topology based on the industrial field level communication requirement. The wireless communication topology includes a master device, at least one field device, at least one network device, and at least one wireless communication link. The method includes mapping the industrial field level communication requirement to a network requirement. The method includes determining at least one communication parameter for the at least one configured wireless communication link based on the network requirements, the wireless communication topology, or a combination thereof. The method includes transmitting the at least one communication parameter to at least one device.

### FIELD

The subject matter disclosed herein relates generally to wireless communications and more particularly relates to configuring a wireless communication topology.

### BACKGROUND

In certain wireless communications networks, different communication topologies may be used. Devices in such networks may need to be configured to operate with a specific topology.

### BRIEF SUMMARY

Methods for configuring a wireless communication topology are disclosed. Apparatuses and systems also perform the functions of the methods. One embodiment of a method includes obtaining an industrial field level communication requirement for configuring a wireless communication topology for at least one time sensitive communication application. In some embodiments, the method includes determining the wireless communication topology for the at least one time sensitive communication application based on the industrial field level communication requirement. The wireless communication topology includes a master device, at least one field device, at least one network device, and at least one wireless communication link. In certain embodiments, the method includes mapping the industrial field level communication requirement to a plurality of network requirements corresponding to the at least one configured wireless communication link of the determined wireless communication topology. In various embodiments, the method includes determining at least one communication parameter for the at least one configured wireless communication link based on the plurality of network requirements, the determined wireless communication topology, or a combination thereof. In some embodiments, the method includes transmitting the at least one communication parameter to at least one device.

One apparatus for configuring a wireless communication topology includes a processor that: obtains an industrial field level communication requirement for configuring a wireless communication topology for at least one time sensitive communication application; determines the wireless communication topology for the at least one time sensitive communication application based on the industrial field level communication requirement, wherein the wireless communication topology includes a master device, at least one field device, at least one network device, and at least one wireless communication link; maps the industrial field level communication requirement to a plurality of network requirements corresponding to the at least one configured wireless communication link of the determined wireless communication topology; and determines at least one communication parameter for the at least one configured wireless communication link based on the plurality of network requirements, the determined wireless communication topology, or a combination thereof. In various embodiments, the apparatus includes a transmitter that transmits the at least one communication parameter to at least one device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a wireless communication topology;

FIG. 2 is a schematic block diagram illustrating one embodiment of an apparatus that may be used for configuring a wireless communication topology;

FIG. 3 is a schematic block diagram illustrating one embodiment of an apparatus that may be used for configuring a wireless communication topology;

FIG. 4 is a schematic block diagram illustrating one embodiment of translation of a field topology to a network topology;

FIG. 5 is a schematic block diagram illustrating one embodiment of a system configuration;

FIG. 6 is a schematic block diagram illustrating another embodiment of a system configuration;

FIG. 7 is a network communications diagram illustrating one embodiment of communications for a message sequence;

FIG. 8 is a schematic block diagram illustrating one embodiment of a network topology;

FIG. 9 is a schematic block diagram illustrating one embodiment of a network topology with traffic schedules;

FIG. 10 is a flowchart diagram illustrating one embodiment of a a method for a network topology update;

FIG. 11 is a network communications diagram illustrating one embodiment of communications for configuration at a device side; and

FIG. 12 is a flow chart diagram illustrating one embodiment of a method for configuring a wireless communication topology.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

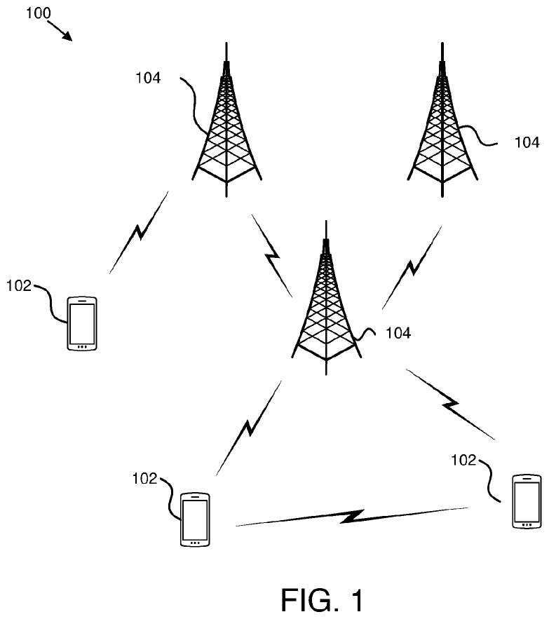

FIG. 1 depicts an embodiment of a wireless communication system 100 for configuring a wireless communication topology. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a Service Enabler Architecture Layer (“SEAL”) function, a vertical application enabler server, an edge enabler server, an edge configuration server, a mobile edge computing platform function, a mobile edge computing application, a middleware entity, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In certain embodiments, a network unit 104 may obtain an industrial field level communication requirement for configuring a wireless communication topology for at least one time sensitive communication application. As used herein, industrial field level communication requirements may refer to field-level networking requirements (e.g., for sensor, actuator, or device buses) and/or controller to field device networking requirements in industrial automation systems. Moreover, as used herein, a time sensitive communication application may refer to an application requiring deterministic or isochronous communication with high reliability and availability, such as IEEE TSN and IETF DetNet, over wireless networks. Further, as used herein, an application may refer to an application function, an application server, an application client, an application enabler server, an application enabler client, a vertical application specific server, a vertical application specific client, and/or an API invoker. Such terms may be understood in 3GPP and/or may be defined in TS 23.434, TS 23.222, TS 23.558, TS 23.286, and/or TS 23.501. In some embodiments, the network unit 104 may determine the wireless communication topology for the at least one time sensitive communication application based on the industrial field level communication requirement. The wireless communication topology includes a master device, at least one field device, at least one network device, and at least one wireless communication link. It should be noted that, as used herein, a master device and a controller may be the same entities. Moreover, a field device may be a slave device, and may be a sensor, an actuator, an I/O device, or a fieldbus device that connects to multiple sensors and/or actuators. Further, the at least one wireless communication link is among any of the master, field, and network devices. In certain embodiments, the network unit 104 may map the industrial field level communication requirement to a plurality of network requirements corresponding to the at least one configured wireless communication link of the determined wireless communication topology. In various embodiments, the network unit 104 may determine at least one communication parameter for the at least one configured wireless communication link based on the plurality of network requirements, the determined wireless communication topology, or a combination thereof. In some embodiments, the network unit 104 may transmit the at least one communication parameter to at least one device. Accordingly, the network unit 104 may be used for configuring a wireless communication topology.

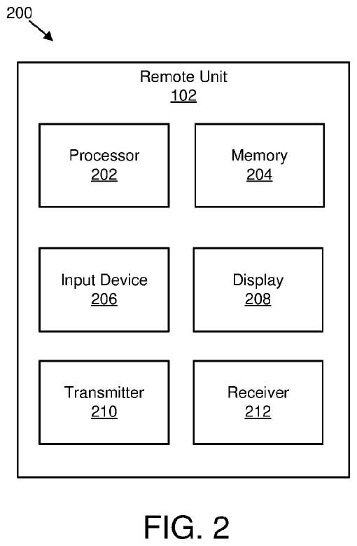

FIG. 2 depicts one embodiment of an apparatus 200 that may be used for configuring a wireless communication topology. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

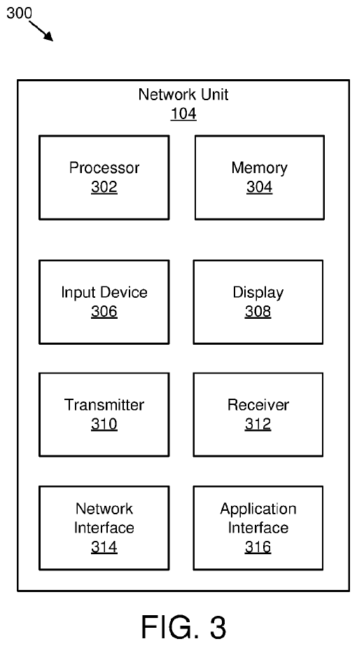

FIG. 3 depicts one embodiment of an apparatus 300 that may be used for configuring a wireless communication topology. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively. The apparatus 300 also includes a network interface 314 for communication with a network, and an application interface 316 for communication with one or more applications.

In certain embodiments, the processor 302: obtains an industrial field level communication requirement for configuring a wireless communication topology for at least one time sensitive communication application; determines the wireless communication topology for the at least one time sensitive communication application based on the industrial field level communication requirement, wherein the wireless communication topology includes a master device, at least one field device, at least one network device, and at least one wireless communication link; maps the industrial field level communication requirement to a plurality of network requirements corresponding to the at least one configured wireless communication link of the determined wireless communication topology; and determines at least one communication parameter for the at least one configured wireless communication link based on the plurality of network requirements, the determined wireless communication topology, or a combination thereof. In various embodiments, the transmitter 310 transmits the at least one communication parameter to at least one device.

In certain embodiments, there may be support for time sensitive and/or deterministic communications within a third generation partnership program (“3GPP”) system. This support may be valid for integration with time sensitive networks (“TSN”) and/or for fifth generation (“5G”) native time sensitive communication (“TSC”) services.

In some embodiments, controller to controller and controller to device communication in field level communications may be important due to time criticality and availability requirements. Certain applications for such embodiments may be motion control services and process automation. Such applications may use closed-loop interactions between the controller and numerous field devices (e.g., sensors, actuators, fieldbus devices, cameras, input/output (“I/O”) devices.

In various embodiments, such as in industrial internet of things (“IIoT”) there may be different technologies and/or fieldbus protocols for automation. In such embodiments, inside a machine (e.g., device and sensor levels), protocols with hard real-time capabilities (e.g., real-time Ethernet) may dominate (e.g., EtherCAT, Profibus, Sercos). In certain embodiments, there may be application-level solutions that combine with TSN.

In some embodiments, a master and/or controller communicates with a pre-determined group of field devices and/or slave devices. The field topology may be determined or updated from a set of topologies (e.g., ring, star, tree, daisy chain, bus): 1) based on pre-configuration; 2) based on different application and/or service requirement (e.g., multiple applications at each device may require different topologies); 3) based on dynamic changes at the application side (e.g., due to addition and/or removal of a field device and/or sensor); 4) based on a communication model to be used; and/or 5) based on the slice customer requirements (e.g., if an original equipment manufacturer (“OEM”) uses private slices from a mobile network operator (“MNO”) and requires different isolation level per slice, this may result in a different grouping of field devices).

In various embodiments, if a fifth generation system (“5GS”) is used for communication between a controller and field devices, field topology requirements may be mapped to a network topology. This may include possible links to be used, as well as topology parameters, which may be an order of active wireless links over a service cycle (e.g., motion control cycle), a type of transmission, and a quality of service (“QoS”) setting for network sessions within a service cycle.

In certain embodiments, there may be different network topologies to be selected and/or configured to meet the requirements of a domain based on field topology and technology use. This may be based on: 1) air interface used for device communication (e.g., device to device interface (“PC5”) or device to network interface (“Uu”)); 2) modes of transmission (e.g., unicast, groupcast, broadcast); 3) dependencies among commands between field devices (e.g., slave #1 transmits to slave #2, conditionally to successful decoding of datagram #1 by slave #1); 4) common datagrams to be read by the same sub-set of field devices (e.g., datagram #1 to be read by slave #2, #3); 5) a level of determinism (e.g., whether it is per communication link or per service cycle), which may necessitate communication link redundancy; 6) whether traffic is expected to be periodic or aperiodic; and/or 7) a number of machine applications sending different datagrams and/or packets in each cycle that are processed differently by each slave.

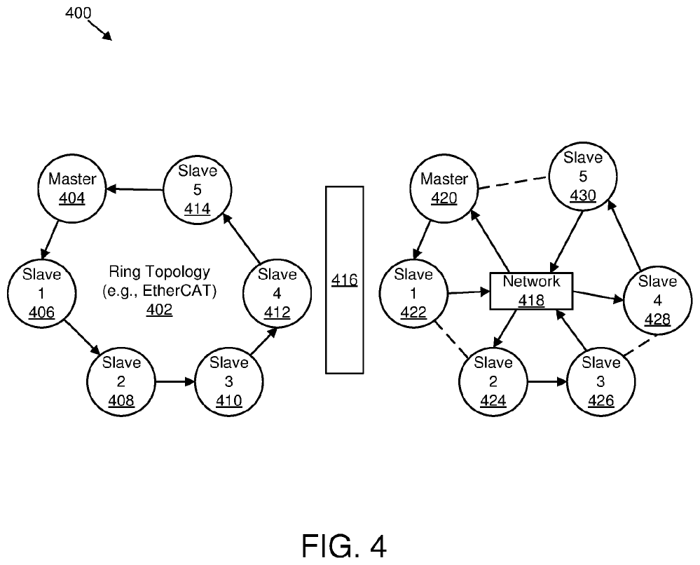

One embodiment for EtherCAT ring topology which may be mapped to different network topologies as illustrated in FIG. 4. In this example, a master may communicate with slaves in a pre-determined order (e.g., based on an EtherCAT cycle that is pre-defined (e.g., not the same as the service cycle). The communication may be over sidelink if the devices are close to each other or via Uu (e.g., if the devices are far, or non-line of sight (“NLOS”) exists). The communication network topology may differ from a ring field topology.

FIG. 4 is a schematic block diagram 400 illustrating one embodiment of translation of a field topology to a network topology. A ring topology 402 (e.g., field topology, EtherCAT) includes a master 404, a slave 1 406, a slave 2 408, a slave 3 410, a slave 4 412, and a slave 5 414. A translation 416 of the field topology to a network topology is illustrated. The network topology for a network 418 includes a master 420, a slave 1 422, a slave 2 424, a slave 3 426, a slave 4 428, and a slave 5 430.

In some embodiments, it may be unknow how to perform a translation between a requirement from a domain (e.g., the topology requirement, a protocol to be used, and other factors), and a network and/or communication topology. A translation may be needed because: 1) a vertical may not care about how traffic is routed at a 5GS bridge (e.g., it requires that ring topology is maintained and key performance indicators (“KPIs”) are fulfilled; 2) MNO may not provide network configuration parameters to the vertical and a control of which interfaces and modes of transmissions are used; 3) network topology may be shaped based on different interfaces (e.g., Uu, PC5), transmission modes (e.g., unicast, groupcast, broadcast), transmission schedules over the 5G network—this is a task of the MNO to handle to make sure that the application requirements are met; 4) dependencies among devices requiring the same datagrams and/or the same time need to be captured-will require from a network to provide routing and/or scheduling mechanisms to guarantee that packets will be received at a given time window; 5) dependencies among devices triggered conditionally to fulfil a requirement (e.g., slave #2 transmits after slave #1 fulfils a task)—will require from the network to set constraints on a traffic schedule and means of communication; and/or 6) wireless access related conditions may require adaptation of communication links (e.g., interference, resource unavailability) to make sure that the requirements based on the field topology are met.

In various embodiments, it may be determined: 1) how to configure a mapping and/or translation of a field level IIOT topology requirements to a network topology to ensure meeting application QoS requirements for an end-to-end service-if field level communication is 5G-enabled and/or assisted; 2) how to configure the interface selection (e.g., Uu, PC5), transmission mode, and network QoS mapping to ensure meeting KPI for an end-to-end service (e.g., motion control cycle, process automation cycle); and/or 3) how to dynamically adapt routing of the traffic based on changes in the configuration of a group and network interfaces (e.g., if a new device is onboarded on the fly).

Certain embodiments described herein provide a mechanism at a middleware for configuring the mapping of industrial field level requirements (e.g., including topology, IIoT protocols for field level communication, and so forth) to a 5GS-enabled topology, and the configuration of necessary parameters for enabling controller to device and device to device communications over 5GS.

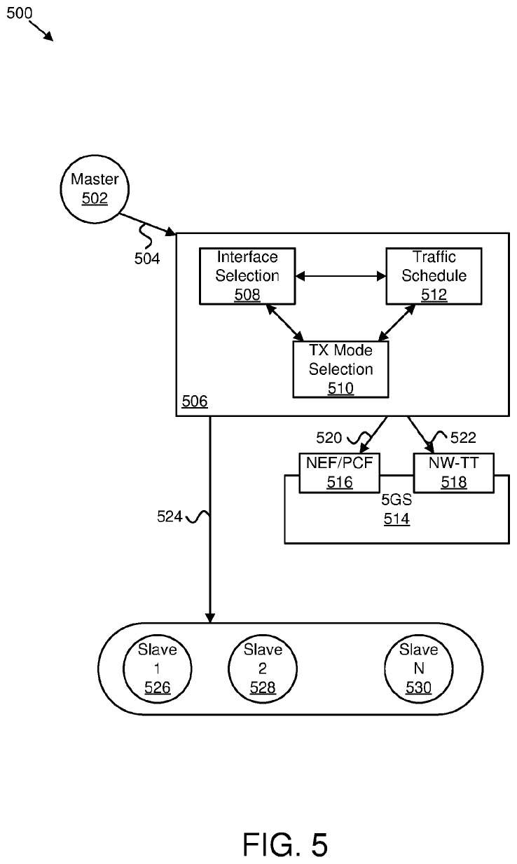

FIG. 5 is a schematic block diagram illustrating one embodiment of a system configuration 500. The system configuration 500 includes a master device 502 (e.g., which may be an application specific server or an application at a user equipment (“UE”) based on a deployment option) sends 504 a requirement and/or request to middleware 506 and/or a field level topology configurator (“FLTC”) to configure the topology within 5GS. This request may include context information related to a TSC session. Moreover, the context information may include a list of slave devices including their identities and/or addresses, slave UE capabilities (e.g., whether they have device side TSN translator (“DS-TT”) or not, whether they are middleware aware), the topology requirement (e.g., based on an industrial field-level communication requirement), a protocol and/or technology (e.g., open platform communications under architecture (“OPC-UA”) field level communications (“FLC”), Ethernet for control automation technology (“EtherCAT”)), a level of integration with 5GS (e.g., no integration if 5G-native, or integration with TSN that will identify the role of FLTC as TSN, TSC application function (“AF”), and/or centralized network controller (“CNC”)). The constraints for transmissions among devices (e.g., common datagrams, timing constraints, conditions for triggering a slave device to transmit) may also be sent in the request. As may be appreciated, in IEEE TSN standards, the CNC acts as a proxy for a network (e.g., the TSN bridges and their interconnections) and the control applications that require deterministic communication. The CNC defines the schedules on which all TSN frames are transmitted.

In some embodiments, the middleware 506 configures mapping of vertical requirements to a communication network-driven topology. Specifically, the middleware 506 jointly configures: 1) interface selection 508: a type of radio interfaces to be used per pair of devices (e.g., Uu or PC5); 2) a transmit (“TX”) mode selection 510: a transmission mode for master to slave communication (e.g., unicast, groupcast, broadcast); and 3) a traffic schedule 512: application traffic schedule, sequence of transmissions with a 5GS 514, QoS profiles and/or requirements to be used per PC5 and Uu sessions.

In various embodiments, the middleware 506 sends, via communication links 520, 522, and 524, the configuration parameters of to each 3GPP UE device (e.g., master, slave devices—slave 1 526, slave 2 528, slave N 530) as well as to a network user plane (“UP”) (e.g., user plane function (“UPF”) and/or network side TSN translator (“NW-TT”) 518) and control plane (“CP”) (e.g., network exposure function (“NEF”) and/or policy control function (“PCF”) 516).

In certain embodiments, the middleware 506, acting as TSN AF, provides configuration for QoS and port management related parameters to NW-TT 518 and/or UPF as well as to device side TSN translator (“DS-TT”) (e.g., hold-and-buffer may be fine-tuned to send packets to a slave application, exactly at a timeslot that is needed). In some embodiments, TSN AF to NW-TT and/or DS-TT transfers port or bridge management information.

In various embodiments, the middleware 506, acting as AF configures application QoS parameters (e.g., using settings for an AF session with required QoS procedure). In certain embodiments, the middleware 506 sends to client-side enabling applications a configuration of transmission modes, QoS parameters, and a type of interface to be used. This information may be used at the slave devices as provisioning policies and/or parameters for communication with other devices (e.g., directly or indirectly).

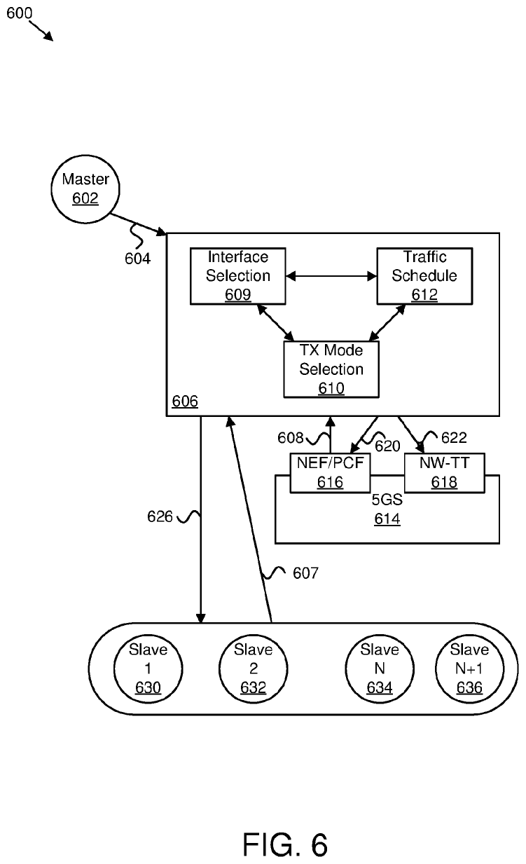

FIG. 6 is a schematic block diagram illustrating another embodiment of a system configuration 600. The system configuration 600 may include a master device 602.

A trigger event may be captured by middleware 606 with communication 604, 607, and/or 608. The trigger event may come from the master device 602 or from a network side and may be: 1) application triggered: for example, a new slave device (e.g., sensor) is added at the topology-thus the network topology requirements will need to be adapted; and/or 2) communication triggered: a predicted and/or expected QoS change for one or more communication links—this may be either for the Uu-based communications (e.g., QoS sustainability analytics via NEF), for PC5 based communication based on reporting via application layer (e.g., channel loss, jitter, load)>Thresh), or based on UE and/or group UE location monitoring from the middleware (e.g., by using service enabler architecture layer (“SEAL”) services or fifth generation core network (“5GC”) location service (“LCS”))

In some embodiments, the middleware 606 configures mapping of vertical requirements to a communication network-driven topology. Specifically, the middleware 606 jointly configures: 1) interface selection 609: a type of radio interfaces to be used per pair of devices (e.g., Uu or PC5); 2) a TX mode selection 610: a transmission mode for master to slave communication (e.g., unicast, groupcast, broadcast); and 3) a traffic schedule 612: application traffic schedule, sequence of transmissions with a 5GS 614, QOS profiles and/or requirements to be used per PC5 and Uu sessions.

In various embodiments, the middleware 606 sends, via communication links 620, 622, and 626, the configuration parameters of to each 3GPP UE device (e.g., master, slave devices—slave 1 630, slave 2 632, slave N 634, slave N+1 636) as well as to a network UP (e.g., UPF and/or NW-TT 618) and CP (e.g., NEF) and/or policy control function PCF 616).

In certain embodiments, the middleware 606, acting as TSN AF, provides configuration for the QoS and port management related parameters to NW-TT 618 and/or UPF as well as to DS-TT (e.g., hold-and-buffer may be fine-tuned to send packets to a slave application, exactly at a timeslot that is needed).

In various embodiments, the middleware 606, acting as AF configures application QoS parameters (e.g., using settings for an AF session with required QoS procedure).

In a first embodiment, there may be a topology configuration at a server-side.

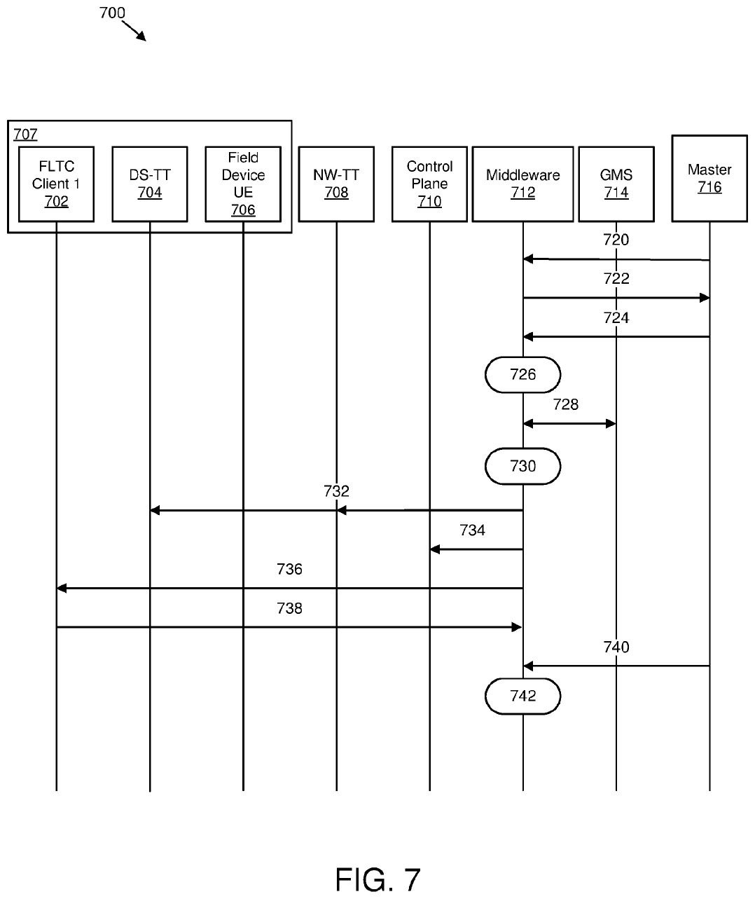

FIG. 7 is a network communications diagram illustrating one embodiment of communications 700 for a message sequence. The communications 700 illustrated are between an FLTC client 1 702 (e.g., or TSC application), a DS-TT 704, a field device 706 (the FLTC client 1 702, the DS-TT 704, and the field device 706 may all be part of the same device 707), an NW-TT 708 (e.g., UPF), a control plane 710 (e.g., 5GC control plane), a middleware device 712 (e.g., and/or FLTC), a group management server (“GMS”) 714 (e.g., SEAL server), and a master device 716 (e.g., TSN system, controller). As may be appreciated, each of the communications 700 may include one or more messages.

In a first communication 720 transmitted from the master device 716 to the middleware device 712, the master device 716 sends a requirement to the middleware device 712 to handle network topology enablement for TSC sessions (e.g., service request).

In a second communication 722 transmitted from the middleware device 712 to the master device 716, the middleware device 712 sends a response to the request as a result (e.g., positive or negative acknowlegement).

In a third communication 724 transmitted from the master device 716 to the middleware device 712, the master device 716 sends 724 to the middleware device 712 additional configuration information. This additional configuration information may include a datagram mapping configuration from a EtherCAT system. Moreover, the additional configuration information may include a device address which can be a node address (e.g., configured station address and/or alias for each slave device) or a physical address, and a mapping of the device address to a list of logical addresses (e.g., which identifies the permissions of each slave device over the datagrams).

The master device 716 may also send topological information necessary to the middleware device 712. This topological information may include: configuration of the devices, a TSC service identifier, a protocol and/or a technology for field level communication, a field topology, UE capabilities, a level of integration with 5GS, a public land mobile network (“PLMN”) and/or non-public network (“NPN”) identity, expected UE trajectories, end-to-end QoS requirements, restrictions for grouping and/or interfaces (e.g., based on capabilities of UEs), dependencies among devices for frame delivery, timing requirements for the datagram reception, location of access points and/or base stations (“BSs”; default and priority of interfaces (e.g., Uu, PC5), and/or transmission modes per device.

The middleware device 712 processes 726 the request and performs jointly a mapping to transmission modes, interface selection, and traffic routing based on the requirements received (e.g., to meet end-to-end requirements for a service cycle).

In certain embodiments, initially, a radio interface is selected for every two nodes. This may be done by checking for every two devices, the hypothetical benefits for using Uu or PC5. In other words, whether the in-direct and/or direct interaction can or cannot fulfil the KPIs, by checking a per link cost if these two nodes need to be connected. The determination may be based on the following criteria: application preference, an actual and/or expected distance of all the devices within the service, expected relative positioning for the entire session (e.g., to assure reachability based on the planned route), calculated and/or average signal to noise ratio (“SNR”) and/or path loss for the candidate for the PC5 and Uu links (e.g., based on location of involved nodes-devices, access points) and route of UEs), NLOS probability (e.g., for the direct links, based on map), and/or expected load of Uu and PC5 interfaces in an area.

In some embodiments, based on the selected links, an initial topology may be created. For this topology, a graph may be created where a root node is the UPF (assuming that the master device 716 is connected to network via UPF). A node in the graph may be a slave device or a network (“NW”) node (e.g., UPF and/or BS). An edge may be a selected communication link between any two nodes in the graph. Each edge may be weighted based on an estimated latency (e.g., propagation+processing) on the communication link.

In various embodiments, if there are devices with dependencies and/or conditional triggering (e.g., condition is the reception of the previous packet or the order to transmission based on a predefined field topology), then these nodes may be removed from the graph and may be replaced with a new node (e.g., super-user which represents all nodes within a group) which has inbound edges: the edges to the first device in the order and/or sequence, and outbound edges: the edges of the last device in the order and/or sequence. The middleware device 712 generates a group identifier (“ID”) (e.g., using GMS services, or acting as GMS) for each set of devices with conditional triggering, and an order within the group (e.g., based on dependencies). For each group, the set of datagrams applying to all members may be bundled together. The group ID and the group parameters (e.g., type of group, order of devices, datagram mapping per device) may be stored at the middleware device 712.

In certain embodiments, for the resulting graph, the middleware device 712 performs optimal route selection to reach all the devices with a minimum number of parallel routes, starting from the UPF and/or BS, having as a constraint a latency requirement per destination device and an end-to-end upper delay bound (e.g., end-to-end for a service cycle: master-UPF/BS—slave #x,y,z-BS/UPF-master). One algorithm for determining this may be based on implementation (e.g., different options can be provided). In one example, the algorithm may be a branch-and-cut exact algorithm.

In some embodiments, a resulting routing may include one or more parallel routes from the NW to the slave devices (e.g., including direct links between slave devices). For the parallel routes from the NW to UEs in the same area or with similar data and/or timing constraints, the middleware device 712 may decide to bundle packets and form a multicast group to transmit traffic together.

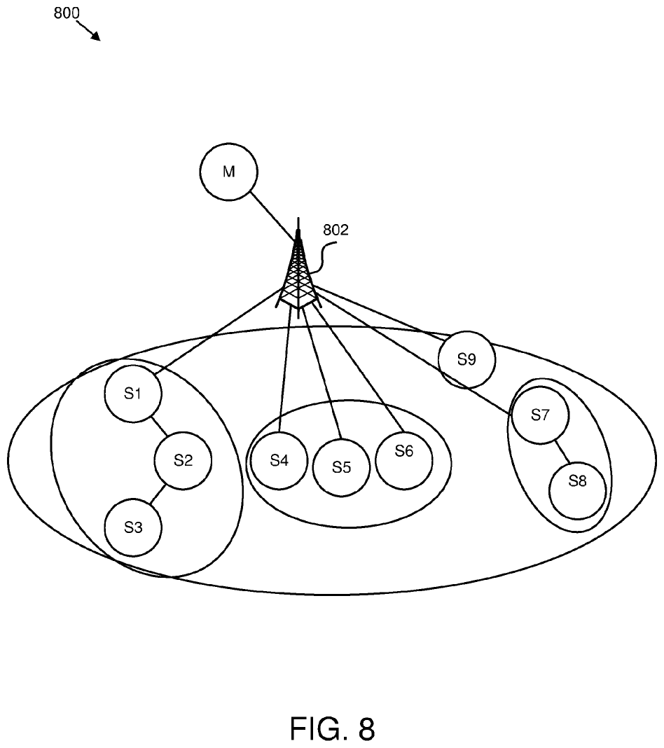

FIG. 8 is a schematic block diagram illustrating one embodiment of a network topology 800. The network topology 800 includes a base station 802, a master device M, and slave devices S1, S2, S3, S4, S5, S6, S7, S8, and S9. S1-S2-S3 (e.g., PC5 interface) as well as S7-S8 have dependencies, and S4-S5-S6 (e.g., Uu interface) require the same datagrams at the same time.

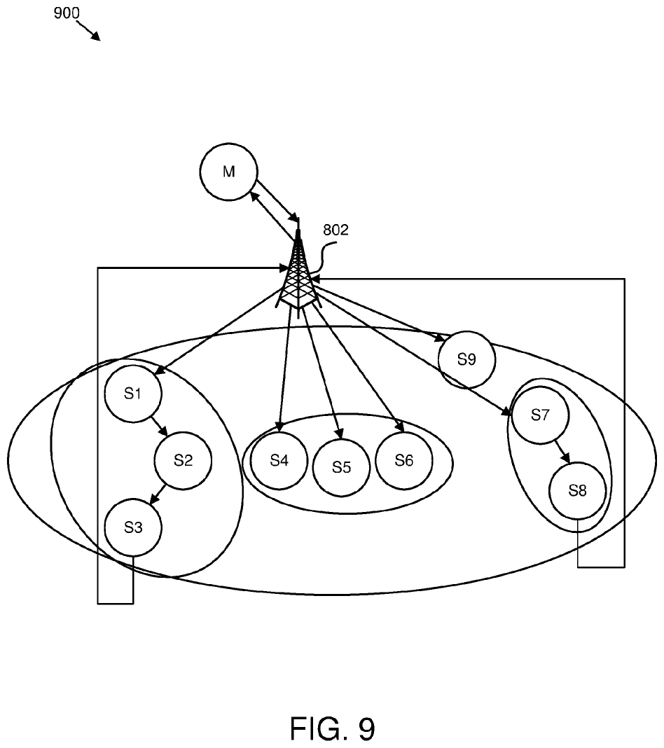

FIG. 9 is a schematic block diagram illustrating one embodiment of a network topology 900 with traffic schedules. The network topology 900 includes the base station 802, a master device M, and slave devices S1, S2, S3, S4, S5, S6, S7, S8, and S9. S1-S2-S3 (e.g., PC5 interface) as well as S7-S8 have dependencies, and S4-S5-S6 (e.g., Uu interface) require the same datagrams at the same time. The traffic schedule is as follows based on the different groupings. Specifically, for S1-S2-S3, M transmits to the base station 802, which transmits to S1, then S2, then S3, then to the base station 802. Moreover, for S4-S5-S6, M transmits to the base station 802, which transmits directly to each of S4, S5, and S6. Further, for S7-S8, M transmits to the base station 802, which transmits to S7, then S8, then the base station 802. For S9, M transmits to the base station 802, which transmits to S9.

Returning to FIG. 7, in a fourth communication 728 transmitted between the middleware device 712 and the GMS 714, the middleware device 712 sends a group formation request to the GMS 714 for the TSC service. The request indicates a service ID and type. The GMS 714 generates or acquires a group ID and sends back a response to the middleware device 712. In some embodiments, the middleware device 712 may acquire the group ID without the GMS 712 (e.g., using credentials from the network or based on a pre-configuration).

The middleware device 712, for each slave device session, configures 730 QoS attributes and translates application QOS requirements to communication requirements per protocol data unit (“PDU”) session or PC5 session, and provides this information to 5GC and/or to the application clients at involved UEs.

In a fifth communication 732 transmitted from the middleware device 712 to the DS-TT 704 and/or in a sixth communication 734 transmitted from the middleware device 712 to the control plane 710, the middleware device 712, acting as TSN AF, sends to the NW-TT 708 (and optionally the DS-TT 704) a transmission schedule (per device and group), datagrams per device and per group (e.g., bundling as determined). Also, the middleware device 712 sends to the control plane 710 functions (e.g., PCF) a group identifier for sequential groups and for multicast groups, a transmission mode per session, an interface selection per session, and/or application QoS parameters (e.g., using setting up an AF session with required QoS procedure. This can be sent in a form of a directed graph indicating the order to links to be activated for a given time window.

In one embodiment, the middleware device 712, acting as a TSN AF, may provide configuration information within an Nnef_ParameterProvisioning_Create request where the request may include group identifier information, UE configuration parameters (e.g., transmission schedule, transmission mode, radio interface selection (e.g., PC5 and/or Uu)—the configuration information may also include 5G virtual network (“VN”) group information (e.g., a cluster is configured as a 5G-LAN group). The PCF, based on the configuration parameters, may provide updated universal software radio peripheral (“URSP”) rules for each field device UE indicating the interface priority (e.g., PC5 or Uu) for transmission of datagrams.

In a seventh communication 736 transmitted from the middleware device 712 to the FLTC client 1 702, the middleware device 712 may send to client-side enabling applications the configuration of the parameters described herein. This configuration may include port management policies if there is no NW-TT 708 and DS-TT 704 at the slave devices (e.g. in 5G-native TSC). In that case, this includes application QoS and port management policies to FLTC clients of slave devices (e.g., acting as translators).

In certain embodiments, a trigger event may be captured by the middleware device 712. Such trigger event may come from the master device 716 or from the network side.

In some embodiments, an eight communication 738 may be transmitted from the FLTC client 1 702 to the middleware device 712 (e.g., communication triggered). In such embodiments, a predicted and/or expected QoS and/or context change may be triggered for one or more communication links. This can be either for Uu-based communications (e.g., QoS sustainability analytics via NEF), for PC5-based communication based on reporting via an application layer (e.g., channel loss, jitter, load>Thresh), and/or based on a UE and/or group UE location monitoring from the middleware device 712 (e.g., by using SEAL services, 5GC, and/or LCS).

A trigger event report may include the following parameters: a vertical application layer (“VAL”) UE ID, a VAL service ID, a VAL group ID, an application session ID, a TSC and/or TSN service ID, a QoS and/or quality of experience (“QoE”) attribute change indication (e.g., based on a pre-defined threshold), a UE location and/or mobility change indication, a UE and/or group UE location reporting (e.g., coordinates, civic address, and so forth), and/or a predicted QoS and/or QoE attribute change indication.

In various embodiments, a ninth communication 740 may be transmitted from the master device 716 to the middleware device 712 (e.g., application triggered). In such embodiments, an application requirement may be received from the master device 716 or a TSC application specific server. The application requirement may be related to a new slave addition or the change of a service profile for the application. Such update configuration may include the following parameters: a VAL service ID, a VAL group ID, an application session ID, a TSC and/or TSN service ID, a new service profile identifier and/or KPI, an updated topology requirement, an updated protocol requirement, an addition and/or removal of a field device and/or member within the topology, an updated application QOS requirement, and/or an application relocation and/or migration requirement (e.g., to a new edge data network (“EDN”))

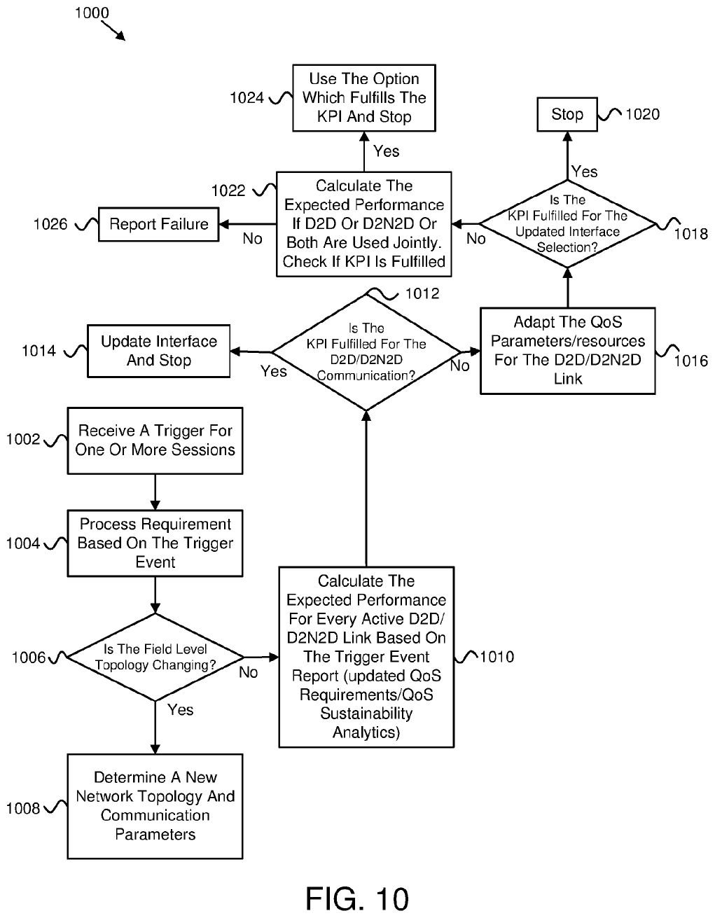

The middleware device 712, evaluates 742 the triggering event and adapts the configuration of the topology based on the evaluation. If the trigger event is a change of the field topology (e.g., if a device is added or removed), then the adaptation includes step 726 through 736. If a change is needed based on change of communication link and/or path conditions or a change of application QoS requirements, then the adaptation of the configuration may be only at the radio interface selection and/or the QoS attributes for one or more network and/or PC5 sessions. This may be performed as described in relation to FIG. 10.

FIG. 10 is a flowchart diagram illustrating one embodiment of a method 1000 for a network topology update. The method 1000 includes receiving 1002 a trigger event for one or more sessions. Moreover, the method 1000 includes processing 1004 requirements based on the trigger event. Further, the method 1000 includes determining 1006 whether a field level topology is changing. If the method 1000 determines that the field level topology is changing, the method 1000 determines 1008 a new topology and communication parameters (e.g., as in steps 726 through 736).

If the method 1000 determines that the field level topology is not changing, the method 1000 calculates 1010 the expected performance for every active device to device (“D2D”) and/or device to network to device (“D2N2D”) link based on the trigger event report (e.g., updated QoS sustainability analytics). A device may be a master device, a controller, a fieldbus device, a slave device, a sensor, an actuator, and/or an I/O device. The method 1000 then determines 1012 whether the KPI is fulfilled for the D2D and/or D2N2D communication. If the method 1000 determines that the KPI is not fulfilled, the method 1000 updates 1014 the interface and stops.

If the method 1000 determines that the KPI is fulfilled, the method 1000 adapts 1016 the QoS parameters and/or resources for the D2D and/or D2N2D link. The method 1000 then determines 1018 whether the KPI is fulfilled for the updated interface selection. If the method 1000 determines that the KPI is fulfilled, the method 1000 stops 1020.

If the method 1000 determines that the KPI is not fulfilled, the method 1000 calculates 1022 the expected performance is D2D and/or D2N2D are used jointly. The method 1000 then checks to see if the KPI is fulfilled. If the KPI is fulfilled, the method 1000 uses 1024 the option which fulfills the KPI and stops. If the KPI is not fulfilled, the method 1000 reports 1026 a failure.

In a second embodiment, a topology configuration may be performed at a client-side. In certain embodiments, an FLTC is a middleware device at a master device which has 3GPP UE capabilities. In such embodiments, the configuration is performed locally at the master device side, and the configuration of the topology is passed via sidelink communication to slave devices. Moreover, in such embodiments, the middleware device also configures DS-TT and allows the DS-TT to DS-TT configuration for a D2D communication (e.g., to allow the slave to devices to know which port to use for which interface).

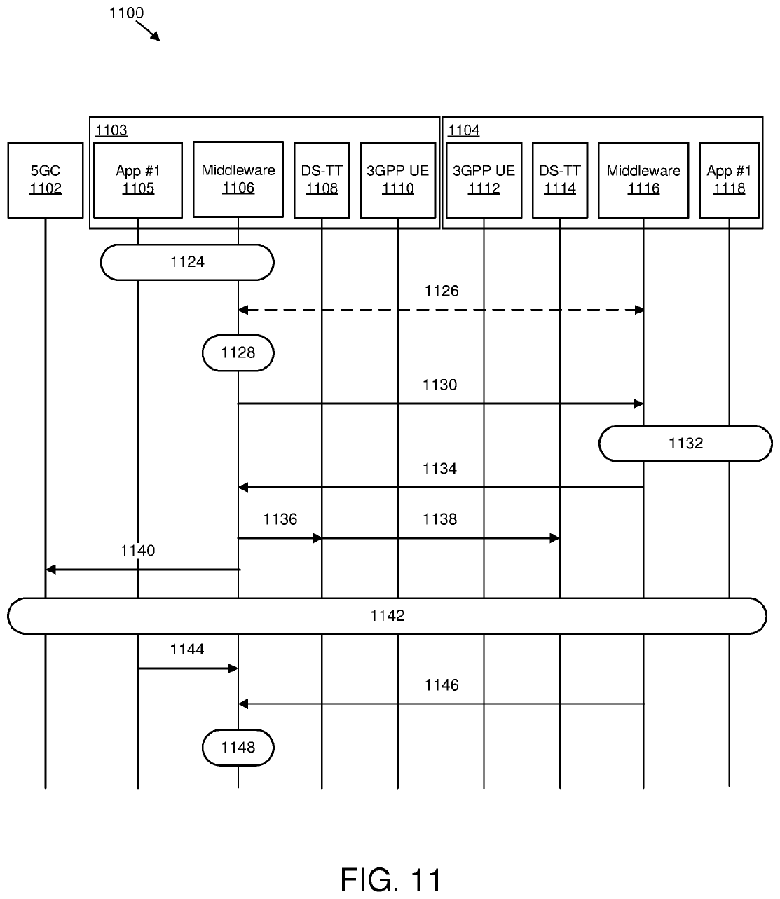

FIG. 11 is a network communications diagram illustrating one embodiment of communications 1100 for configuration at a device side. The communications 1100 may include messages transmitted between a 5GC 1102 (e.g., TSN, AF, PCF), a control and/or master (“C/M”) device 1103, and a sensor and/or actuator (“S/A”) device 1104 (e.g., may include one or more S/A devices). The C/M device 1103 includes an application #1 1105 (e.g., motion control), a middleware device 1106 (e.g., FLTC), an optional DS-TT 1108, and a 3GPP UE 1110. Moreover, the S/A device 1104 includes a 3GPP UE 1112, an optional DS-TT 1114, a middleware device 1116, and an application #1 1118. As may be appreciated, each of the communications 1100 may include one or more messages.

In a first communication 1124 transmitted between the application #1 1105 and the middleware device 1106, the application #1 1105 of the master device (e.g., motion control application) requests that the middleware device 1106 perform topology enablement, and may also provide configuration parameters.

In an optional second communication 1126 transmitted between the middleware device 1106 and the middleware device 1116, the middleware device 1106 at the master device may establish a session with the middleware device 1116 of one or more slave devices in a group. Such establishment may enable the master to provide notifications to the slave devices and to configure the reporting required from the other middleware layers.

The middleware device 1106 processes the request and performs jointly a mapping to transmission modes, interface selection, mapping of per link communication requirements to QoS profiles and/or level, and traffic routing based on the requirements of step 1124 (e.g., to meet the end-to-end requirements for the service cycle). In some embodiments, a master UE acts as a UE gateway (“GW”) for other UEs. The middleware device 1106 may process the information based on any embodiments described herein.

In a third communication 1130 transmitted from the middleware device 1106 to the middleware device 1116, the middleware device 1106 sends to other middleware devices 1116 the configuration of the topology. This may be in a form of a request or command and/or notification (e.g., based on whether a session is already established) and may be sent via unicast, groupcast, and/or broadcast communication over an application layer. Such configuration includes the following parameters: a VAL service ID, application ID, session ID, list of VAL UE IDs (e.g., master and slaves), group IDs, for each pair of VAL UE IDs, an indication of the communication interface (e.g., direct vs in-direct) and the transmission mode, a traffic schedule, an order of transmissions, a timetable of transmissions for a time window (e.g., service cycle), service cycle requirements, traffic requirements, performance requirements, grouping information (e.g., for sequential groups), QOS requirements per communication link, and/or geographical area and/or time validity for the topology configuration.

In a fourth communication 1132 transmitted between the middleware device 1116 and the application #1 1118, the middleware devices 1116 of the slave devices may interact with relevant corresponding applications to configure the application QoS requirements for slave device communication (e.g., to map to physical downlink shared channel (“PDSCH”) rate matching and quasi-co-location indicator (“PQI”), 5G QoS identifier (“5Q1”) parameters). Then, in a fifth communication 1134 transmitted from the middleware device 1116 to the middleware device 1106, the middleware device 1116 (or devices) transmit a response (e.g., acknowledgement, negative acknowledgment, etc) to the middleware device 1106.

In a sixth communication 1136 transmitted from the middleware device 1106 to the DS-TT 1108 and in a seventh communication 1138 transmitted from the middleware device 1106 to the DS-TT 1114, the middleware device 1106 of the master device may configure the DS-TT 1108 of the master device as well as the DS-TT 1114 of other slave devices with port management policies related to the use of a PC5 or Uu interface. The middleware device 1106 may act as a TSN AF within the master. Such policies may also relate to the stop and buffer configuration based on the topology mapping to ensure meeting the TSC flow requirements.

In an eighth communication 1140 transmitted from the middleware device 1106 to the 5GC 1102, the middleware device 1106 of the master may send the configuration to the 5GC CP to notify and/or align determined topology. In one embodiment, the middleware device 1106, acting as a TSN AF (or interacting with TSN AF), may provide configuration information within an Nnef_ParameterProvisioning_Create request and in the request may include group identifier information, UE configuration parameters (e.g., transmission schedule, radio interface selection (e.g., PC5 and/or Uu)). The configuration information may also include 5G VN group information (e.g., a cluster configured as a 5G-LAN group). The PCF, based on the configuration parameters, may provide updated UE route selection policy (“URSP”) rules for each field device UE indicting the interface priority (PC5 or Uu) for transmission of datagrams.

Then, an operation phase 1142 is performed (e.g., PC5 session, PDU session establishments and/or modifications based on a selection of link, modes, and/or QoS parameters).

A trigger event may be captured by the middleware device 1106. Such trigger event may be as described in steps 1144 or 1146.

In a nineth communication 1144 transmitted from the application #1 1105 to the middleware device 1106 (e.g., communication triggered), a predicted, expected QoS, and/or context change for one or more communication links is transmitted from the application #1 1105. This may be either for Uu-based communications (e.g., QoS sustainability analytics via NEF), for PC5-based communication based on reporting via application layer (e.g., channel loss, jitter, load)>Thresh), or based on UE and/or group UE location monitoring from the middleware device 1106.

The trigger event report may include the following parameters: a VAL UE ID, a VAL service ID, an application session ID, a TSC and/or TSN service ID, a QoS and/or QoE attribute change indication (e.g., based on a pre-defined threshold), a UE location and/or mobility change indication, a UE and/or group UE location reporting (e.g., coordinates, civic address), and/or a predicted QoS and/or QoE attribute change indication.

In a tenth communication 1146 transmitted from the middleware device 1116 to the middleware device 1106 (e.g., application triggered), a new application requirement may be transmitted. Such new requirement may be related to a new slave addition or the change of the service profile for the application. Such update configuration may include the following parameters: a VAL service ID, an application session ID, a TSC and/or TSN service ID, a new service profile identifier and/or KPI, an updated topology requirement, an updated protocol requirement, an addition and/or removal of a field device and/or member within the topology, an updated application QoS requirement, an application relocation and/or migration requirement (e.g., to a new EDN).

The middleware device 1106 evaluates 1148 the triggering event and adapts the configuration of the topology based on the evaluation. If the trigger event is the change of the field topology (e.g., if a device is added or removed), then the adaptation includes the steps 1130 through 1140. If a change is needed based on change of communication link and/or path conditions or the change of application QoS requirements, then the adaptation of the configuration may be only at the radio interface selection and/or the QoS attributes for one or more network and/or PC5 sessions. This step performed may be as described in relation to FIG. 10.

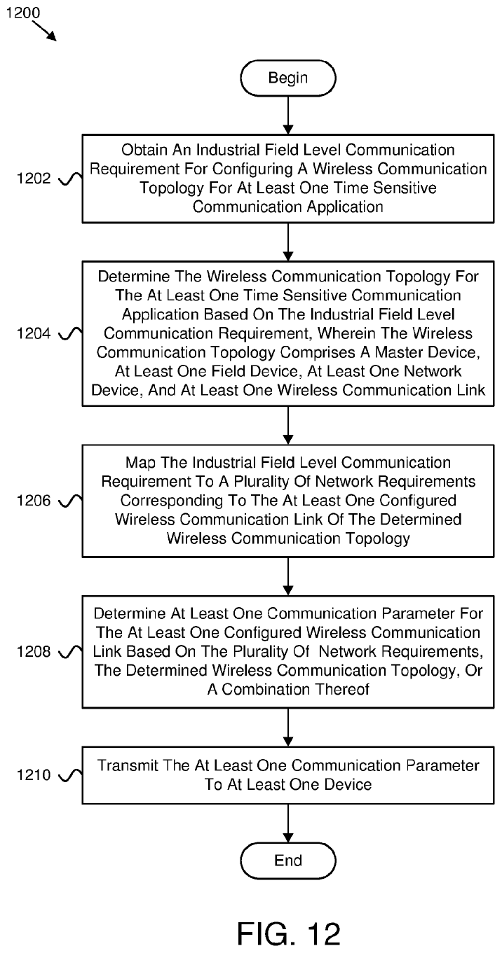

FIG. 12 is a flow chart diagram illustrating one embodiment of a method 1200 for configuring a wireless communication topology. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes obtaining 1202 an industrial field level communication requirement for configuring a wireless communication topology for at least one time sensitive communication application. In some embodiments, the method 1200 includes determining 1204 the wireless communication topology for the at least one time sensitive communication application based on the industrial field level communication requirement. The wireless communication topology includes a master device, at least one field device, at least one network device, and at least one wireless communication link. In certain embodiments, the method 1200 includes mapping 1206 the industrial field level communication requirement to a plurality of network requirements corresponding to the at least one configured wireless communication link of the determined wireless communication topology. In various embodiments, the method 1200 includes determining 1208 at least one communication parameter for the at least one configured wireless communication link based on the plurality of network requirements, the determined wireless communication topology, or a combination thereof. In some embodiments, the method 1200 includes transmitting 1210 the at least one communication parameter to at least one device.

In certain embodiments, obtaining the industrial field level communication requirement comprises receiving the industrial field level communication requirement from a controller, the master device, a centralized network controller, a time sensitive network system, an application server, an application function, or some combination thereof. In some embodiments, the industrial field level communication requirement comprises an industrial field topology for the at least one time sensitive communication application. In various embodiments, the industrial field level communication requirement comprises an application quality of service requirement, a field level communication protocol requirement, a port management policy requirement, a quality of experience requirement, device to datagram mapping information, a field device configuration, or some combination thereof.

In one embodiment, the plurality of network requirements comprises at least one quality of service requirement. In certain embodiments, the at least one communication parameter comprises a radio interface, a transmission mode, a quality of service parameter, an application transmission schedule, or some combination thereof. In some embodiments, the transmission mode comprises a unicast communication mode, a groupcast communication mode, or a broadcast communication mode.

In various embodiments, transmitting the at least one communication parameter to the at least one device comprises transmitting the at least one communication parameter to the at least one device via a user plane or a control plane. In one embodiment, the method 1200 further comprises receiving a trigger event report.

In certain embodiments, the trigger event report comprises a user equipment identifier, a service identifier, a group identifier, an application session identifier, time sensitive network service identifier, an attribute change indication, a user equipment location change indication, a user equipment mobility change indication, a user equipment location reporting, a group of user equipment location reporting, a predicted attribute change indication, a service profile identifier, an updated topology requirement, an updated protocol requirement, an indication of an addition of a field device, an indication of a removal of a field device, an updated application quality of service requirement, an application relocation requirement, or some combination thereof.

In some embodiments, the method 1200 further comprises updating the wireless communication topology based on the trigger event report. In various embodiments, the method 1200 further comprises determining at least one updated communication parameter for the at least one wireless communication link based on the trigger event report. In one embodiment, the method 1200 further comprises transmitting the at least one updated communication parameter to the at least one device that uses the at least one wireless communication link.

In one embodiment, a method comprises: obtaining an industrial field level communication requirement for configuring a wireless communication topology for at least one time sensitive communication application; determining the wireless communication topology for the at least one time sensitive communication application based on the industrial field level communication requirement, wherein the wireless communication topology comprises a master device, at least one field device, at least one network device, and at least one wireless communication link; mapping the industrial field level communication requirement to a plurality of network requirements corresponding to the at least one configured wireless communication link of the determined wireless communication topology; determining at least one communication parameter for the at least one configured wireless communication link based on the plurality of network requirements, the determined wireless communication topology, or a combination thereof; and transmitting the at least one communication parameter to at least one device.

In certain embodiments, obtaining the industrial field level communication requirement comprises receiving the industrial field level communication requirement from a controller, the master device, a centralized network controller, a time sensitive network system, an application server, an application function, or some combination thereof.

In some embodiments, the industrial field level communication requirement comprises an industrial field topology for the at least one time sensitive communication application.

In various embodiments, the industrial field level communication requirement comprises an application quality of service requirement, a field level communication protocol requirement, a port management policy requirement, a quality of experience requirement, device to datagram mapping information, a field device configuration, or some combination thereof.

In one embodiment, the plurality of network requirements comprises at least one quality of service requirement.

In certain embodiments, the at least one communication parameter comprises a radio interface, a transmission mode, a quality of service parameter, an application transmission schedule, or some combination thereof.

In some embodiments, the transmission mode comprises a unicast communication mode, a groupcast communication mode, or a broadcast communication mode.

In various embodiments, transmitting the at least one communication parameter to the at least one device comprises transmitting the at least one communication parameter to the at least one device via a user plane or a control plane.

In one embodiment, the method further comprises receiving a trigger event report.

In certain embodiments, the trigger event report comprises a user equipment identifier, a service identifier, a group identifier, an application session identifier, time sensitive network service identifier, an attribute change indication, a user equipment location change indication, a user equipment mobility change indication, a user equipment location reporting, a group of user equipment location reporting, a predicted attribute change indication, a service profile identifier, an updated topology requirement, an updated protocol requirement, an indication of an addition of a field device, an indication of a removal of a field device, an updated application quality of service requirement, an application relocation requirement, or some combination thereof.

In some embodiments, the method further comprises updating the wireless communication topology based on the trigger event report.

In various embodiments, the method further comprises determining at least one updated communication parameter for the at least one wireless communication link based on the trigger event report.

In one embodiment, the method further comprises transmitting the at least one updated communication parameter to the at least one device that uses the at least one wireless communication link.

In one embodiment, an apparatus comprises: a processor that: obtains an industrial field level communication requirement for configuring a wireless communication topology for at least one time sensitive communication application; determines the wireless communication topology for the at least one time sensitive communication application based on the industrial field level communication requirement, wherein the wireless communication topology comprises a master device, at least one field device, at least one network device, and at least one wireless communication link; maps the industrial field level communication requirement to a plurality of network requirements corresponding to the at least one configured wireless communication link of the determined wireless communication topology; and determines at least one communication parameter for the at least one configured wireless communication link based on the plurality of network requirements, the determined wireless communication topology, or a combination thereof; and a transmitter that transmits the at least one communication parameter to at least one device.

In certain embodiments, the apparatus further comprises a receiver, wherein the processor obtaining the industrial field level communication requirement comprises the receiver receiving the industrial field level communication requirement from a controller, the master device, a centralized network controller, a time sensitive network system, an application server, an application function, or some combination thereof.

In some embodiments, the industrial field level communication requirement comprises an industrial field topology for the at least one time sensitive communication application.

In various embodiments, the industrial field level communication requirement comprises an application quality of service requirement, a field level communication protocol requirement, a port management policy requirement, a quality of experience requirement, device to datagram mapping information, a field device configuration, or some combination thereof.

In one embodiment, the plurality of network requirements comprises at least one quality of service requirement.

In certain embodiments, the at least one communication parameter comprises a radio interface, a transmission mode, a quality of service parameter, an application transmission schedule, or some combination thereof.

In some embodiments, the transmission mode comprises a unicast communication mode, a groupcast communication mode, or a broadcast communication mode.

In various embodiments, the transmitter transmitting the at least one communication parameter to the at least one device comprises transmitting the at least one communication parameter to the at least one device via a user plane or a control plane.

In one embodiment, the apparatus further comprises a receiver that receives a trigger event report.

In certain embodiments, the trigger event report comprises a user equipment identifier, a service identifier, a group identifier, an application session identifier, time sensitive network service identifier, an attribute change indication, a user equipment location change indication, a user equipment mobility change indication, a user equipment location reporting, a group of user equipment location reporting, a predicted attribute change indication, a service profile identifier, an updated topology requirement, an updated protocol requirement, an indication of an addition of a field device, an indication of a removal of a field device, an updated application quality of service requirement, an application relocation requirement, or some combination thereof.

In some embodiments, the processor updates the wireless communication topology based on the trigger event report.

In various embodiments, the processor determines at least one updated communication parameter for the at least one wireless communication link based on the trigger event report.

In one embodiment, the transmitter transmits the at least one updated communication parameter to the at least one device that uses the at least one wireless communication link.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
obtaining an industrial field level communication requirement for configuring a wireless communication topology for at least one time sensitive communication application;
determining the wireless communication topology for the at least one time sensitive communication application based on the industrial field level communication requirement, wherein the wireless communication topology comprises a master device, at least one field device, at least one network device, and at least one wireless communication link;
mapping the industrial field level communication requirement to a plurality of network requirements corresponding to the at least one configured wireless communication link of the determined wireless communication topology;
determining at least one communication parameter for the at least one configured wireless communication link based on the plurality of network requirements, the determined wireless communication topology, or a combination thereof; and
transmitting the at least one communication parameter to at least one device.

2. The method of claim 1, wherein obtaining the industrial field level communication requirement comprises receiving the industrial field level communication requirement from a controller, the master device, a centralized network controller, a time sensitive network system, an application server, an application function, or some a combination thereof.

3. The method of claim 1, wherein the industrial field level communication requirement comprises an industrial field topology for the at least one time sensitive communication application.

4. The method of claim 1, wherein the industrial field level communication requirement comprises an application (QOS) requirement, a field level communication protocol requirement, a port management policy requirement, a (QoE) requirement, device to datagram mapping information, a field device configuration, or a combination thereof.

5. The method of claim 1, wherein the plurality of network requirements comprises at least one (QOS) requirement.

6. The method of claim 1, wherein the at least one communication parameter comprises a radio interface, a transmission mode, a (QOS) parameter, an application transmission schedule, or a combination thereof.

7. The method of claim 6, wherein the transmission mode comprises a unicast communication mode, a groupcast communication mode, or a broadcast communication mode.

8. The method of claim 1, wherein transmitting the at least one communication parameter to the at least one device comprises transmitting the at least one communication parameter to the at least one device via a user plane or a control plane.

9. The method of claim 1, further comprising obtaining a trigger event report.

10. The method of claim 9, wherein the trigger event report comprises a user equipment (UE) identifier (ID), a service (ID), a group (ID), an application session (ID), time sensitive network service (ID), an attribute change indication, a (UE) location change indication, a (UE) mobility change indication, a (UE) location reporting, a group of (UE) location reporting, a predicted attribute change indication, a service profile (ID), an updated topology requirement, an updated protocol requirement, an indication of an addition of a field device, an indication of a removal of a field device, an updated application (QOS) requirement, an application relocation requirement, or a combination thereof.

11. The method of claim 9, further comprising updating the wireless communication topology based on the trigger event report and determining at least one updated communication parameter for the at least one wireless communication link based on the trigger event report.

12. The method of claim 11, further comprising transmitting the at least one updated communication parameter to the at least one device that uses the at least one wireless communication link.

13. A user equipment (UE), comprising:
at least one memory; and
at least one processor coupled with the at least one memory and configured to cause the UE to:
obtain an industrial field level communication requirement for configuring a wireless communication topology for at least one time sensitive communication application;
determine the wireless communication topology for the at least one time sensitive communication application based on the industrial field level communication requirement, wherein the wireless communication topology comprises a master device, at least one field device, at least one network device, and at least one wireless communication link;
map the industrial field level communication requirement to a plurality of network requirements corresponding to the at least one configured wireless communication link of the determined wireless communication topology;
determine at least one communication parameter for the at least one configured wireless communication link based on the plurality of network requirements, the determined wireless communication topology, or a combination thereof; and
transmit the at least one communication parameter to at least one device.

14. The UE of claim 13, wherein the at least one processor is configured to cause the UE to obtain the industrial field level communication requirement by receiving the industrial field level communication requirement from a controller, the master device, a centralized network controller, a time sensitive network system, an application server, an application function, or a combination thereof.

15. The UE of claim 13, wherein the industrial field level communication requirement comprises an application (QOS) requirement, a field level communication protocol requirement, a port management policy requirement, a (QoE) requirement, device to datagram mapping information, a field device configuration, or a combination thereof.

16. The UE of claim 13, wherein the at least one communication parameter comprises a radio interface, a transmission mode, a (QOS) parameter, an application transmission schedule, or a combination thereof.

17. The UE of claim 13, wherein the at least one processor is configured to cause the UE to obtain a trigger event report.

18. The UE of claim 17, wherein the trigger event report comprises a UE identifier (ID), a service (ID), a group (ID), an application session (ID), time sensitive network service (ID), an attribute change indication, a (UE) location change indication, a (UE) mobility change indication, a (UE) location reporting, a group of (UE) location reporting, a predicted attribute change indication, a service profile (ID), an updated topology requirement, an updated protocol requirement, an indication of an addition of a field device, an indication of a removal of a field device, an updated application (QOS) requirement, an application relocation requirement, or a combination thereof.

19. The UE of claim 17, wherein the at least one processor is configured to cause the UE to update the wireless communication topology based on the trigger event report, and determine at least one updated communication parameter for the at least one wireless communication link based on the trigger event report.

20. (canceled)

21. A processor for wireless communication, comprising:
at least one controller coupled with at least one memory and configured to cause the processor to:
obtain an industrial field level communication requirement for configuring a wireless communication topology for at least one time sensitive communication application;
determine the wireless communication topology for the at least one time sensitive communication application based on the industrial field level communication requirement, wherein the wireless communication topology comprises a master device, at least one field device, at least one network device, and at least one wireless communication link;
map the industrial field level communication requirement to a plurality of network requirements corresponding to the at least one configured wireless communication link of the determined wireless communication topology;
determine at least one communication parameter for the at least one configured wireless communication link based on the plurality of network requirements, the determined wireless communication topology, or a combination thereof; and
transmit the at least one communication parameter to at least one device.
